(19) United States
(12) Patent Application Publication
(10) Pub. No.: US 2021/0268702 A1
(43) Pub. Date: Sep. 2, 2021

(54) INJECTION MOLDING DIE, AND METHOD OF MANUFACTURING MOLDED PRODUCT

(71) Applicant: Kumi Kasei Co., Ltd., Tokyo (JP)

(72) Inventor: Etsuo Okahara, Ube-shi (JP)

(21) Appl. No.: 17/260,586

(22) PCT Filed: Jul. 18, 2019
(86) PCT No.: PCT/JP2019/028225

§ 371 Date: Jan. 15, 2021

(30) Foreign Application Priority Data
Jul. 18, 2018 (JP) 2018-135192

(51) Int. Cl. B29C 45/37; B29C 45/73

(52) U.S. Cl. CPC B29C 45/376; B29C 45/73

(57) ABSTRACT

An injection molding die of the invention is used in a molding method of causing a surface of a resin molded product during molding to be brought into close contact with both cavity surfaces of a pair of dies by setting surface temperatures of cavity surfaces of the pair of dies to be higher than a deformation temperature of a resin to be molded. The injection molding die of the invention is capable of increasing the volume of the cavity along with operation of injecting the resin to a cavity formed by the pair of dies and reducing the volume of the cavity along with contraction of the resin by cooling.

### TECHNICAL FIELD

The present invention relates to an injection molding die and a method of manufacturing a molded product.

This application claims priority from Japanese Patent Application No. 2018-135192 filed on Jul. 18, 2018, the contents of which are incorporated herein by reference in their entirety.

### BACKGROUND ART

For injection molding a resin molded product, for example, in the case of molding a projected portion such as a rib, a boss, a clip base for attachment, or the like on a back surface of a mold, if the above-mentioned projected portion is set to be thick, a recess referred to as a sink is easily formed at a position of a surface of the molded product which corresponds to the projected portion.

As a die that can prevent sink from being generated, a die is known which can cause an inner surface of a cavity die molding a design surface of the molded product to be higher in temperature than a surface of a core die molding a back surface side of the molded product. According to this die, the design surface side of the molded product is brought into close contact with the cavity surface of the die by setting the inner surface of the cavity die to be higher than the surface of the core die, generation of sink is concentrated to the back surface side on the opposite side of the design surface, and sink is prevented from being generated on the design surface (for example, refer to Patent Documents 1 to 3).

However, in the above-described die, heat transfer from the cavity die having a high temperature to the core die occurs at the contact point between the die cavity die and the core die which are in a mold clamping state. Consequently, the difference in temperature between the cavity die and the core die is small, and the adhesion force of the molded resin with respect to the inner surface of the cavity die may be reduced. For this reason, in some cases, it was difficult to prevent sink from being generated on the design surface.

Moreover, when molding a molded product having a projected portion such as rib or the like formed on the back surface of the molded product, sink may not be prevented from being generated on the design surface depending on the positon of the projected portion in the die. For example, in the case in which a region surrounded by ribs or the like exists or in the case in which ribs or the like are arranged close to each other substantially in parallel, in some cases, sink could not be prevented from being generated on the design surface.

Additionally, since the inner surface of the cavity die is higher in temperature than the surface of the core die in the die, there is a problem in that warpage such that the cavity die side (that is, on a high temperature side) are formed in a recessed shape occurs on the molded product.

Furthermore, in the case in which an injection amount of resin increases in the die, it is thought that a contact time of the molded product and a core die having a low temperature becomes longer, a skin layer of the back surface thereby develops, and sink that would be normally concentrated onto the back surface is generated on the design surface. Accordingly, although it is necessary to accurately carry out control of the injection amount, accurate control of the injection amount is not easy, and in some cases, it is difficult to realize stabilized molding conditions. Particularly, in a die used for obtaining a plurality of molded products, there is a demand to stably realize molding conditions for a plurality of molded products.

Moreover, in the die, in the case in which the molded product having sink that is concentrated onto the back surface thereof is adhered to a surface of a separate product by attaching a double-stick tape to the back surface of the molded product and a final configuration for use is thereby obtained, there is a problem in that it is difficult to obtain a desired adhesion strength.

### PRIOR ART DOCUMENTS

### Patent Documents

[Patent Document 1] Japanese Unexamined Patent Application, First Publication No. H6-315961

[Patent Document 2] Japanese Unexamined Patent Application, First Publication No. 2012-192715

[Patent Document 3] Japanese Unexamined Patent Application, First Publication No. 2015-223732

### SUMMARY OF THE INVENTION

### Problems to be Solved by the Invention

An aspect of the invention solves the above problem and provides an injection molding die and a method of manufacturing a molded product, which solve the above-described problem, cause warpage not to occur due to a difference in temperature from being generated on the molded product while stably achieving prevention of sink from being generated on a design surface of a molded product, also prevent sink from being generated on the back surface of the molded product, and furthermore easily realize molding conditions.

### Means for Solving the Problems

One aspect of the invention provides an injection molding die being used in a molding method of causing a surface of a resin molded product during molding to be brought into close contact with both cavity surfaces of a pair of dies by setting surface temperatures of cavity surfaces of the pair of dies to be higher than a deformation temperature of a resin to be molded, the injection molding die being capable of increasing the volume of the cavity along with operation of injecting the resin to a cavity formed by the pair of dies and reducing the volume of the cavity along with contraction of the resin by cooling.

It is preferable that the pair of dies be a first die that molds a first main surface of a resin molded product and a second die having a second molding surface that molds at least part of a second main surface which is opposite to the first main surface of the resin molded product, that the first die include: a first body part; and a first movable piece having a first molding surface that molds at least part of the first main surface, and that the first movable piece be movable in a direction of approaching and separating with respect to the second molding surface.

It is preferable to further include a force-applying body that applies a force to the first movable piece in a direction in which the first movable piece approaches the second molding surface.

It is preferable that the second die include: a second body part; and a second movable piece having the second molding surface, and that the second movable piece be movable in a direction of approaching and separating with respect to the first molding surface.

It is preferable that a distance at which the first movable piece is movable in a direction of approaching and separating with respect to the second molding surface be 10% to 20% of thickness of the resin molded product.

Other aspect of the invention provides a method of manufacturing a molded product, including: a step of injecting and filling the resin in a molten state to a cavity between the first die and the second die in a state in which a temperature of the injection molding die is higher than a deformation temperature of a resin forming the resin molded product; and a step of causing the first movable piece to move in a direction of approaching the second molding surface along with volume contraction of the resin when cooling the first die and the second die, and thereby molding the resin in a state in which the resin is in close contact with a first molding surface and a second molding surface.

Furthermore, other aspect of the invention provides an injection molding die that includes: a first die that molds a first main surface of a resin molded product and a second die having a second molding surface that molds at least part of a second main surface which is opposite to the first main surface of the resin molded product, wherein the first die includes: a first body part; and a first movable piece having a first molding surface that molds at least part of the first main surface, and the first movable piece is movable in a direction of approaching and separating with respect to the second molding surface.

### Effects of the Invention

Accordingly, the aspect of the invention provides an injection molding die and a method of manufacturing a molded product, which cause warpage not to occur due to a difference in temperature from being generated on the molded product while stably achieving prevention of sink from being generated on a design surface of a molded product, also prevent sink from being generated on the back surface of the molded product, and furthermore easily realize molding conditions.

### BRIEF DESCRIPTION OF THE DRAWINGS

FIG. 1A is a cross-sectional front view showing an injection molding die according to a first embodiment of the invention.

FIG. 1B is an enlarged cross-sectional view showing a portion represented by reference letter A shown in FIG. 1A.

FIG. 2A is a side view showing an example of a resin molded product formed by the injection molding die shown in FIG. 1A.

FIG. 2B is a plan view showing a resin molded product shown in FIG. 2A.

FIG. 3A is an explanatory operation flow chart showing a method of manufacturing a resin molded product by use of the injection molding die shown in FIG. 1A and is a cross-sectional front view showing a state immediately after injecting and filling of resin to the injection molding die.

FIG. 3B is an enlarged cross-sectional view showing a portion represented by reference letter B shown in FIG. 3A.

FIG. 4A is an operation flow chart continuous with FIG. 3A and is a cross-sectional front view showing a state after cooling of the resin inside the injection molding die is completed and immediately before opening of the die and removing the molded product.

FIG. 4B is an enlarged cross-sectional view showing a portion represented by reference letter C shown in FIG. 4A.

FIG. 5A is a cross-sectional front view showing an injection molding die according to a second embodiment of the invention.

FIG. 5B is an enlarged cross-sectional view showing a portion represented by reference letter D shown in FIG. 5A.

FIG. 6 is a cross-sectional front view showing an injection molding die according to a third embodiment of the invention.

FIG. 7 is a cross-sectional front view showing an injection molding die according to a fourth embodiment of the invention.

FIG. 8 is an explanatory operation flow chart showing a method of manufacturing a resin molded product by use of the injection molding die shown in FIG. 7 and is a cross-sectional front view showing a state immediately after injecting and filling of resin to the injection molding die.

FIG. 9 is an operation flow chart continuous with FIG. 8 and is a cross-sectional front view showing a state after cooling of the resin inside the injection molding die is completed and immediately before opening of the die and removing the molded product.

FIG. 10 is a cross-sectional front view showing an injection molding die according to a fifth embodiment of the invention.

FIG. 11 is an explanatory operation flow chart showing a method of manufacturing a resin molded product by use of the injection molding die shown in FIG. 10 and is a cross-sectional front view showing a state immediately after injecting and filling of resin to the injection molding die.

FIG. 12 is an operation flow chart continuous with FIG. 11 and is a cross-sectional front view showing a state after cooling of the resin inside the injection molding die is completed and immediately before opening of the die and removing the molded product.

### EMBODIMENTS FOR CARRYING OUT THE INVENTION

Hereinafter, an embodiment to which the invention is applied will be particularly described.

Note that, the drawings used in the following explanation is for explanation of a configuration of the embodiment of the invention, and the sizes, the thickness, the dimensions, or the like of various portions shown in the drawings may be different from the dimensions of the real device.

### (Resin Molded Product)

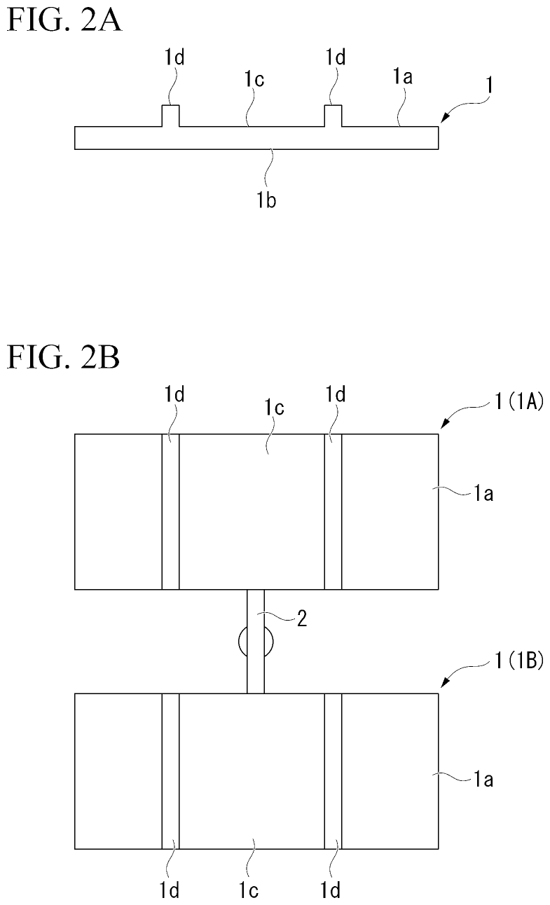

Before explanation of the injection molding die according to the embodiment, an example of a resin molded product formed by the injection molding die will be described. FIG. 2A is a side view showing an example of the resin molded product formed by the injection molding die according to the first embodiment. FIG. 2B is a plan view showing a resin molded product.

FIGS. 2A and 2B show two resin molded products 1 and 1. The two resin molded products 1 and 1 (a first resin molded product 1A and a second resin molded product 1B) are coupled to each other by a connecting portion 2 (also referred to as a runner portion). The resin molded product 1 includes the molded-product main body 1a and one or more projected portions 1d (hereinbelow, also referred to as a molded-product projected portion). The molded-product main body 1a is formed in a plate shape. The molded-product main body 1a has, for example, a rectangular shape when viewed from a thickness direction. One surface of the molded-product main body 1a is a design surface 1b (second main surface). The surface opposite to the design surface 1b is referred to as a back surface 1c (hereinbelow, also referred to as a molded-product main body back surface) (first main surface).

The molded-product projected portion 1d is, for example, a rib that protrudes from the back surface 1c of the molded-product main body 1a. Hereinbelow, the molded-product projected portion 1d is also referred to as “rib”. The projected portions 1d are formed at a plurality of points on the back surface 1c of the molded-product main body 1a. The projected portions 1d (rib) are formed in a projected shape such that protruding ends (projected ends) protruding from the molded-product main body 1a extended parallel to each other. A gap between the projected portions 1d is not particularly limited and may be, for example, less than or equal to two times the thickness of the molded-product main body 1a.

### (Injection Molding Die)

### First Embodiment

Hereinbelow, the injection molding die according to an embodiment will be described with reference to the drawings.

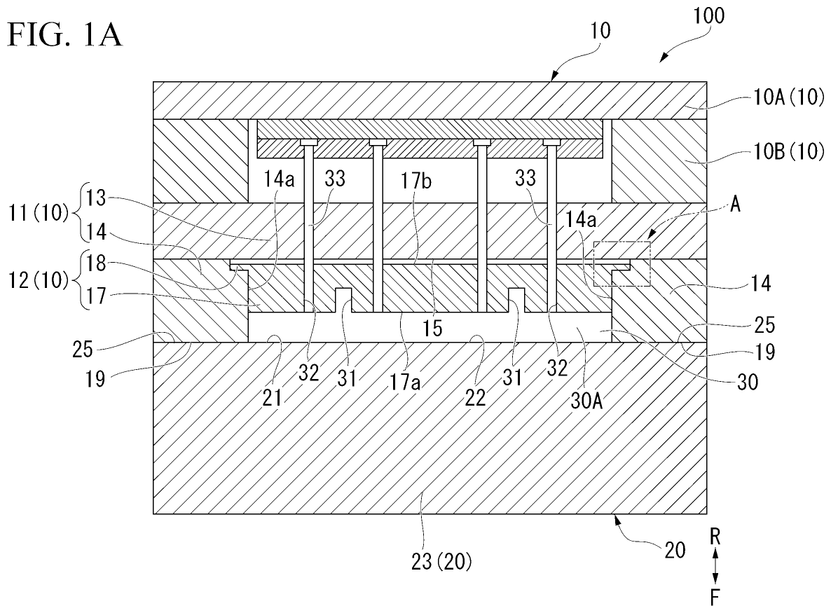

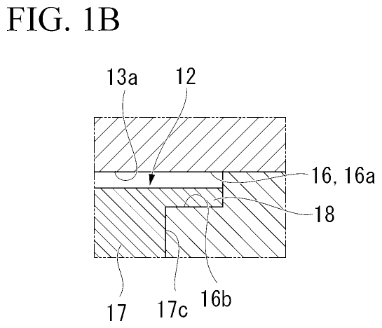

FIG. 1A is a cross-sectional front view showing an injection molding die 100 according to the first embodiment (hereinbelow, also referred to as “die 100”). FIG. 1B is an enlarged cross-sectional view showing a portion represented by reference letter A shown in FIG. 1A. Hereinbelow, the die 100 will be described.

As shown in FIG. 1A, the injection molding die 100 includes a first die 10 (core die) and a second die 20 (cavity die).

In the following explanation, with reference to FIGS. 1A and 1B, the positional relationship between various members will be described. The first die 10 is located above the second die 20. Regarding a first movable piece 12, a forward direction means a downward direction shown in FIG. 1A (direction shown by an arrow F), and a backward direction means an upward direction shown in FIG. 1A (direction shown by an arrow R). FIG. 1A shows a state in which the first die 10 is closed and coupled to the second die 20 (a mold clamping state).

A cavity 30 (air space) is ensured between the first die 10 and the second die 20 (particularly, between the first movable piece 12 and the second die 20). The cavity 30 has a shape corresponding to the resin molded product 1 to be molded (refer to FIGS. 2A and 2B). The die 100 is configured so that resin in a molten state is injected and filled to the cavity 30 from an injection apparatus (not shown in the drawings) through the runner portion.

The first die 10 includes a top plate 10A, a side portion 10B, a first body part 11, and the first movable piece 12.

The first body part 11 includes a based wall portion 13 and a side wall portion 14 that protrudes downward from a peripheral edge portion of the based wall portion 13. The recess formed by the based wall portion 13 and the side wall portion 14 is referred to as a first molding recess 15. A receiving recess 16 that is formed to have a recess directed to the outside is formed at an uppermost portion of an inner surface 14a of the side wall portion 14. An upper surface 16a (back surface) of the receiving recess 16 is on the same plane of a ceiling surface 13a (a lower surface shown in FIG. 1B) of the based wall portion 13. A lower surface 16b (front surface) of the receiving recess 16 is parallel to the upper surface 16a.

The first movable piece 12 includes a movable-piece main body 17 and a stopper 18. The first movable piece 12 is accommodated in the first molding recess 15. The movable-piece main body 17 is formed in a plate shape parallel to the based wall portion 13. A lower surface of the movable-piece main body 17 (a surface facing a main-body molding region 30A of the cavity 30) is a molding surface 17a that is used to mold the back surface 1c of the resin molded product 1 (back-side molding surface, also referred to as a main-body-back-side molding surface in the description) (first molding surface). The main-body-back-side molding surface 17a is formed in a flat shape.

Note that, the main-body-back-side molding surface of the first movable piece has only to be able to mold at least part of the back surface of the resin molded product. For example, of the back surface of the molded product, the main-body-back-side molding surface may be in contact with only a region in which it is necessary to avoid generating sink.

When the first movable piece 12 is located at a forward movement limit (refer to FIGS. 1A and 1B), the main-body-back-side molding surface 17a may be on the same plane of a lower surface 19 (a front-end face of the side wall portion 14 which surrounds an opening of the first molding recess 15) of the first body part 11 which forms a parting surface. When the first movable piece 12 is located at the forward movement limit, the lower portion thereof (a portion including the main-body-back-side molding surface 17a) may protrude downward from the lower surface 19.

A projected-portion molding recess 31 that is depressed from the molding surface 17a and ejector pin holes 32 are formed in the movable-piece main body 17.

The projected-portion molding recess 31 functions as a projected-portion molding region that molds the molded-product projected portions 1d. Regarding the projected-portion molding recess 31, one projected-portion molding recess may be formed so as to correspond to one first movable piece 12 or a plurality of projected-portion molding recesses may be formed. In the first movable piece 12 shown in FIG. 1A, the projected-portion molding recesses 31 are formed in a groove shape at two points of the molding surface 17a. The two projected-portion molding recesses 31 are parallel to each other and is formed away from each other in a width direction (a horizontal direction shown in FIG. 1A) of the projected-portion molding recess 31. Note that, the shape of the projected-portion molding recess is not particularly limited and may be formed in a shape such as an endless polygonal shape, a ring shape, or the like.

The ejector pin holes 32 are formed on the movable-piece main body 17 so as to penetrate from the molding surface 17a to an upper surface 17b (a surface opposite to the molding surface 17a of the movable-piece main body 17). Ejector pins 33 that remove the resin molded product 1 from the first die 10 after completion of molding the resin molded product 1 are inserted into the ejector pin holes 32. By drive of a pin movement device that is not shown in the drawings, the ejector pins 33 can switch between a standby position at which the end portion thereof does not protrude from the cavity 30 and a protruding position at which the end portion protrudes from the cavity 30.

The stopper 18 protrudes from a side surface 17c of the movable-piece main body 17 in a lateral direction. The protruding direction of the stopper 18 is a direction along the molding surface 17a and is a direction away from the movable-piece main body 17. The stopper 18 is formed in a plate shape parallel to the molding surface 17a. The stopper 18 is inserted into the receiving recess 16.

The thickness of the stopper 18, that is, the size thereof in a front-back direction (vertical direction in FIGS. 1A and 1B) is smaller than the size of the receiving recess 16 in the front-back direction. Consequently, the first movable piece 12 is movable in the front-back direction (a direction of approaching and separating with respect to an inside bottom surface 22 of a second molding recess 21).

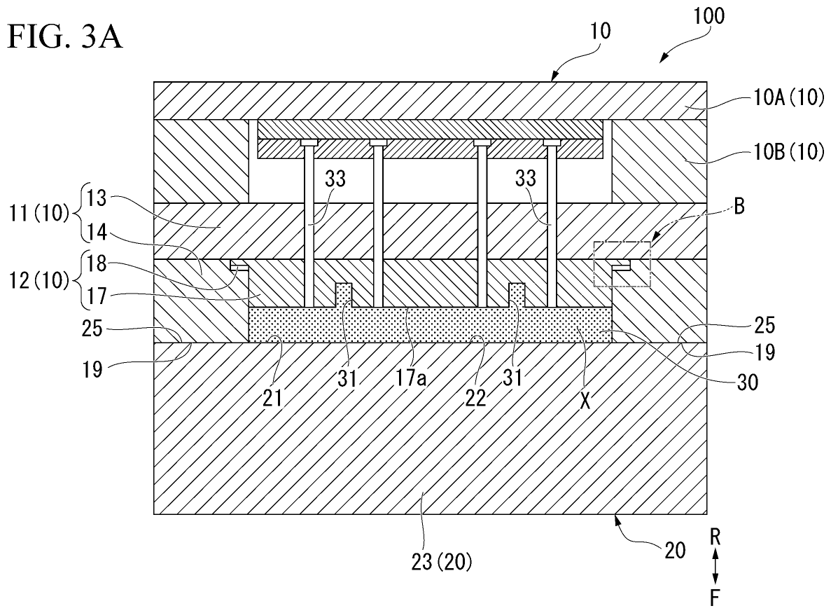

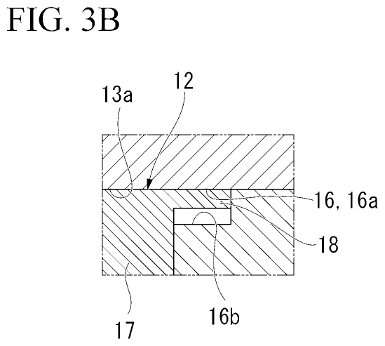

The first movable piece 12 is movable between a forward movement limit shown in FIG. 1B and a backward movement limit shown in FIG. 3B.

Since the stopper 18 comes into contact with the lower surface 16b of the receiving recess 16 at the forward movement limit (refer to FIGS. 1A and 1B), forward movement of the first movable piece 12 is limited. Since the stopper 18 comes into contact with the upper surface 16a of the receiving recess 16 at the backward movement limit (refer to FIGS. 3A and 3B), backward movement of the first movable piece 12 is limited.

The distance at which the first movable piece 12 is movable in the front-back direction (movable distance in the front-back direction) is preferably 10% of the thickness of the resin molded product. For example, it is preferable that this distance be greater than or equal to 0.2 mm. Accordingly, when molding the resin, it is easy to maintain a state in which the resin is in close contact with the main-body-back-side molding surface 17a and the inside bottom surface 22.

It is preferable that the movable distance in the front-back direction of the first movable piece 12 be less than or equal to one-fifth of the thickness of the resin molded product 1 (the thickness of the molded-product main body 1a), that is, less than or equal to 20% of the thickness of the resin molded product 1 (the thickness of the molded-product main body 1a). In the case in which the movable distance of the first movable piece 12 in the front-back direction is in this range, smooth movement of the first movable piece 12 in the front-back direction is possible. In other cases, the movable distance of the first movable piece 12 may be greater than 20% of the thickness of the resin molded product 1 (the thickness of the molded-product main body 1a).

The second die 20 includes a base portion 23. A recess that is formed by the base portion 23 and the side wall portion 14 is referred to as a second molding recess 21. Hereinbelow, the inside bottom surface 22 (second molding surface) of second molding recess 21 is also referred to as a design-surface molding surface.

Note that, the design-surface molding surface has only to be able to mold at least part of the back surface of the resin molded product. For example, of the design surface of the molded product, the design-surface molding surface may be in contact with only a region in which it is necessary to avoid generating sink.

The main-body-back-side molding surface 17a of the first die 10 faces the inside bottom surface 22 of the second molding recess 21 of the second die 20 via the cavity 30. The cavity 30 is ensured by closing and coupling the lower surface 19 of the first die 10 and an upper surface 25 of the second die 20 forming a parting surface to each other. The upper surface 25 is a front-end face of the base portion 23 which surrounds an opening of the second molding recess 21.

The cavity 30 is formed by the main-body molding region 30A and the projected-portion molding recesses 31. The main-body molding region 30A is a space surrounded by an inner surface of the second molding recess 21 and the main-body-back-side molding surface 17a. The main-body molding region 30A molds the molded-product main body 1a. The projected-portion molding recesses 31 mold the molded-product projected portions 1d.

The injection molding die 100 may include a temperature regulating mechanism (not shown in the drawings) that independently controls the temperature of the main-body-back-side molding surface 17a of the first die 10 and the temperature of a design-surface molding surface 22 of the second die 20. The temperature regulating mechanism includes: a heating pipe (not shown in the drawings) that is provided at each of the first die 10 and the second die 20; and a fluid heating supplier (not shown in the drawings) that supplies heating fluid (hot liquid, oil, or the like) to the heating pipes. The temperature regulating mechanism supplies the heating fluid heated by the fluid heating supplier to the heating pipe, and thereby heats the first die 10 and the second die 20. Consequently, the temperature of the main-body-back-side molding surface 17a and the temperature of the design-surface molding surface 22 can be controlled. The temperature regulating mechanism can maintain the temperature of the main-body-back-side molding surface 17a and the temperature of the design-surface molding surface 22 to be substantially the same as each other. A circulating configuration may be adopted as the temperature regulating mechanism. The circulating configuration is, for example, a configuration that circulates the heating fluid in the heating pipe to the fluid heating supplier through a connection pipe (returning pipe).

Particularly, as long as the temperature regulating mechanism heats the first die 10 and the second die 20 and can maintain the temperature of the main-body-back-side molding surface 17a and the temperature of the design-surface molding surface 22 to be substantially the same as each other when the resin is molded in the cavity 30, the specific configuration thereof is not particularly limited.

It is preferable that the die 100 be designed such that the resin inside the cavity 30 is approximately 0.1 mm thinner than a predetermined thickness in advance when the first movable piece 12 is located at the forward movement limit. With this configuration, as the resin having an amount such that it is possible to obtain a molded product having a desired thickness is injected and filled to the die 100 in advance, it is possible to prevent the main-body-back-side molding surface 17a of the first movable piece 12 from being separated from the back surface of the molded product even where the contraction of the resin due to cooling progresses.

Each of the first die 10 and the second die 20 is made of a metal.

### (Method of Manufacturing Molded Product)

### First Embodiment

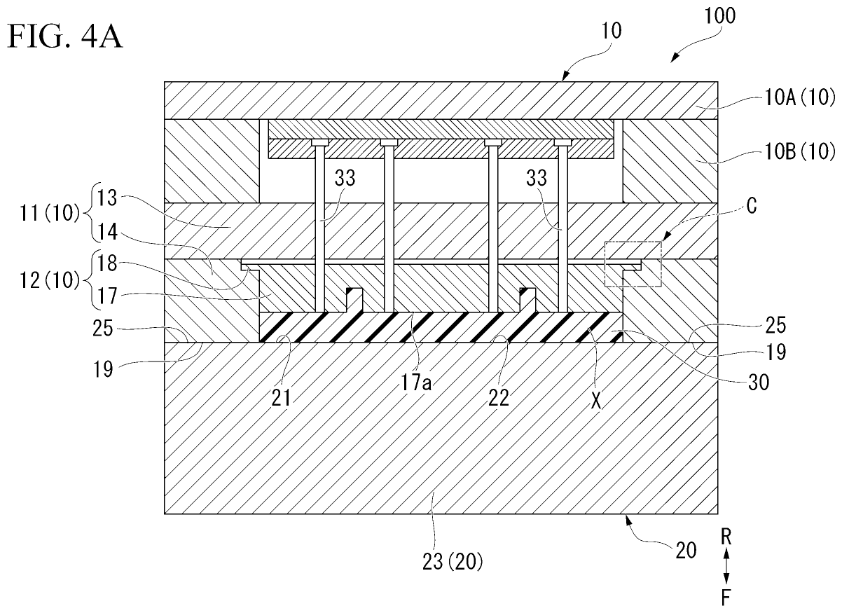

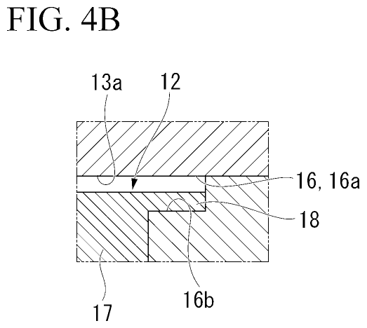

Next, a method of manufacturing the resin molded product 1 by use of the injection molding die 100 will be described with reference to FIGS. 1A, 1B, 3A, 3B, 4A, and 4B. FIG. 3A is an explanatory operation flow chart showing a method of manufacturing the resin molded product 1 by use of the die 100 and is a cross-sectional front view showing a state immediately after injecting and filling of resin to the injection molding die. FIG. 3B is an enlarged cross-sectional view showing a portion represented by reference letter B shown in FIG. 3A. FIG. 4A is an operation flow chart continuous with FIG. 3A and is a cross-sectional front view showing a state after cooling of the resin inside the injection molding die is completed and immediately before opening of the die and removing the molded product. FIG. 4B is an enlarged cross-sectional view showing a portion represented by reference letter C shown in FIG. 4A.

As a resin forming the resin molded product 1, polyolefin resin, polystyrene resin, ABS resin, polymethyl methacrylate (PMMA) resin, polycarbonate resin, polyamide resin, or the like may be adopted.

The manufacturing method according to the embodiment includes the following steps.

First Step (injecting and filling step): a step of injecting and filling the resin in a molten state to the inside of the cavity 30 in a state in which the temperature of the die 100 is higher than the deformation temperature of the injecting and filling resin.

Second Step (cooling step): a step of cooling the resin while reducing the volume of the cavity 30 along with the volume contraction of the resin due to cooling.

Third Step (demolding step): a step of opening the die 100 and demolding the resin molded product 1.

### (First Step: Injecting and Filling Step)

As shown in FIG. 1A, in the injecting and filling step, the first die 10 and the second die 20 is in a mold clamping state. The ejector pins 33 are disposed at the standby position.

As shown in FIG. 3A, the resin X in a molten state is injected and filled to the inside of the cavity 30 in a state in which the temperatures of the first die 10 and the second die 20 are higher than the deformation temperature of the injecting and filling resin X.

Particularly, the resin X in a molten state is injected and filled to the inside of the cavity 30 in a state in which at least the temperatures of the main-body-back-side molding surface 17a and the design-surface molding surface 22 is higher than the deformation temperature of the resin X. Consequently, the resin X is in a state of being in close contact with the main-body-back-side molding surface 17a and the design-surface molding surface 22. The amount of the filling resin X is determined such that the resin molded product 1 has a predetermined plate thickness when the cooling step is completed.

Note that, the deformation temperature of the resin is a value measured under the condition in which a bending load of 1.80 MPa is applied thereto by the method in compliance with JIS K7191-2.

In the injecting and filling step, it is preferable that the difference in temperature between the die 100 and the deformation temperature of the resin X be 5 to 30° C. As long as the difference in temperature is greater than or equal to the lower limit (5° C.) of the above range, it is easy for the resin X to be in a state of being in close contact with the cavity surface (the main-body-back-side molding surface 17a and the design-surface molding surface 22) in the injecting and filling step, and sink is easily prevented from being generated on the molded product. As long as the difference in temperature is less than or equal to the upper limit (30° C.) of the above range, deformation is less likely to occur when removing of the molded product.

In the injecting and filling step, it is preferable to increase the volume of the cavity 30 along with the operation of injecting the resin X. In the injecting and filling step, the amount of the filling resin X can be determined such that, when a resin pressure when injecting and filling of the resin X exceeds a predetermined pressure, the first movable piece 12 moves backward due to the resin pressure, and the volume of the cavity 30 thereby increases. In FIGS. 3A and 3B, the first movable piece 12 is located at the backward movement limit. Accordingly, in the cooling step, it is possible to easily reduce the volume of the cavity 30 along with the volume contraction of the resin X due to cooling. The first movable piece 12 moves in a direction such that the volume of the cavity 30 is reduced by adhesion force between the resin and the first movable piece 12 along with the contraction of the resin due to cooling.

Although the temperatures of the first die 10 and the second die 20 when injecting and filling of resin X may be the same as or different from each other, it is preferable that the temperatures be the same as each other in the point of ease of prevention of the molded product from being warped. By the aforementioned temperature regulating mechanism, it is possible to cause the temperatures of the first die 10 (particularly, the main-body-back-side molding surface 17a) and the second die 20 (particularly, the design-surface molding surface 22) to be the same as each other. When temperatures of the first die 10 and the second die 20 are the same as each other, the adhesion force between the resin X and the first die 10 (particularly, the main-body-back-side molding surface 17a) is equal to the adhesion force between the resin X and the second die 20 (particularly, the design-surface molding surface 22). Accordingly, it is easy to cause the resin X to be in a state of being in close contact with both the main-body-back-side molding surface 17a and the design-surface molding surface 22. As a result, it is easy to obtain a molded product not having sink on both the top surface and the back surface.

### (Second Step: Cooling Step)

As shown in FIG. 4A, in the cooling step, the resin X is cooled down. Since the resin X is in close contact with the main-body-back-side molding surface 17a, the first movable piece 12 moves forward and approaches the second die 20 by adhesion force along with the volume contraction of the resin X due to cooling, and the volume of the cavity 30 is reduced. Consequently, in the cooling step, a state in which the resin X is in close contact with both the main-body-back-side molding surface 17a and the design-surface molding surface 22 is maintained until cooling is completed. Therefore, sink is prevented from being generated on the resin molded product. Moreover, since a state in which the resin X is in close contact with the main-body-back-side molding surface 17a and the design-surface molding surface 22 is maintained, hindering of heat transfer from the resin X to the first die 10 and the second die 20 is prevented. For this reason, the resin X is effectively cooled down for a short period of time.

### (Third Step: Demolding Step)

In the demolding step, the first die 10 and the second die 20 are opened, and the resin molded product 1 (refer to FIGS. 2A and 2B) is pushed out and demolded by movement of the ejector pins 33 from the standby position to the protruding position.

### (Effect Obtained by First Embodiment)

In the injection molding die 100, the first movable piece 12 is movable in a direction of approaching and separating with respect to the design-surface molding surface 22. Because of this, it is possible to reduce the volume of the cavity 30 along with the volume contraction of the resin X when cooling. Accordingly, from the injecting and filling of the resin X to the completion of cooling thereof, a state in which the resin X is in close contact with the main-body-back-side molding surface 17a and the design-surface molding surface 22 can be maintained, and therefore sink is prevented from being generated on the molded product. As a result, the resin molded product 1 having a top surface and a back surface on which sink is not present is obtained. The die 100 is applicable to manufacture of a molded product having both top and back surfaces which are to be a design surface.

From the injecting and filling of the resin X to the completion of cooling thereof, the die 100 can maintain a state in which the resin X is in close contact with the main-body-back-side molding surface 17a and the design-surface molding surface 22, even in the case of a molded product having a projected portion such as a rib or the like, it is possible to prevent sink from being generated thereon. Moreover, even in the case in which the molded product includes a plurality of projected portions and a distance between the projected portions is short (for example, the distance between the two projected portions 1d of the resin molded product 1 is less than or equal to two times the thickness of the molded-product main body 1a), it is possible to prevent sink from being generated on the design surface 1b.

In a die providing a difference in temperature between a design-surface side of the die and a non-design surface side of the die and causing sink to be concentrated to the non-design surface side of the molded product, resin is separated from a cavity surface at the non-design surface side of the molded product, an air heat insulating layer is thereby formed, cooling efficiency of the resin is degraded, a cooling time becomes longer. In contrast, according to the die 100, since a state in which the resin is in close contact with the cavity surfaces (the main-body-back-side molding surface 17a and the design-surface molding surface 22) of the pair of dies is maintained during cooling, hindering of heat transfer from the resin to the first die 10 and the second die 20 is prevented. Consequently, it is possible to shorten a cooling time without lowering the cooling efficiency of the resin, and deformation due to insufficiency of cooling can be prevented.

In the die 100, prevention of sink is possible without providing a difference in temperature between the first die 10 and the second die 20. Since it is not necessary to provide a difference in temperature between the first die 10 and the second die 20, it is possible to prevent the molded product from being curved.

It is conceivable that, in the die providing a difference in temperature between a design-surface side of the die and a non-design surface side of the die and causing sink to be concentrated to the non-design surface side of the molded product, a contact time of the molded product and the low-temperature die becomes longer, and sink that would be normally concentrated onto the back surface is generated on the design surface. In contrast, in the die 100, since a state in which the resin is in close contact with both the cavity surfaces is maintained without depending on the amount of the filling resin, it is possible to prevent sink from being generated. Accordingly, it is possible to realize stabilized molding conditions. For example, in the die used for obtaining a plurality of molded products (the die can manufacture a plurality of molded products) (refer to FIG. 2B), it is possible to stably realize molding conditions for a plurality of the molded products.

In the die 100, as described above, it is possible to manufacture the molded product with the back surface not having sink. As a result, in the case in which the molded product is adhered to a surface of a separate product by attaching a double-stick tape to the back surface of the molded product and a final configuration for use is thereby obtained, it is possible to obtain a sufficient adhesion strength.

### (Injection Molding Die)

### Second Embodiment

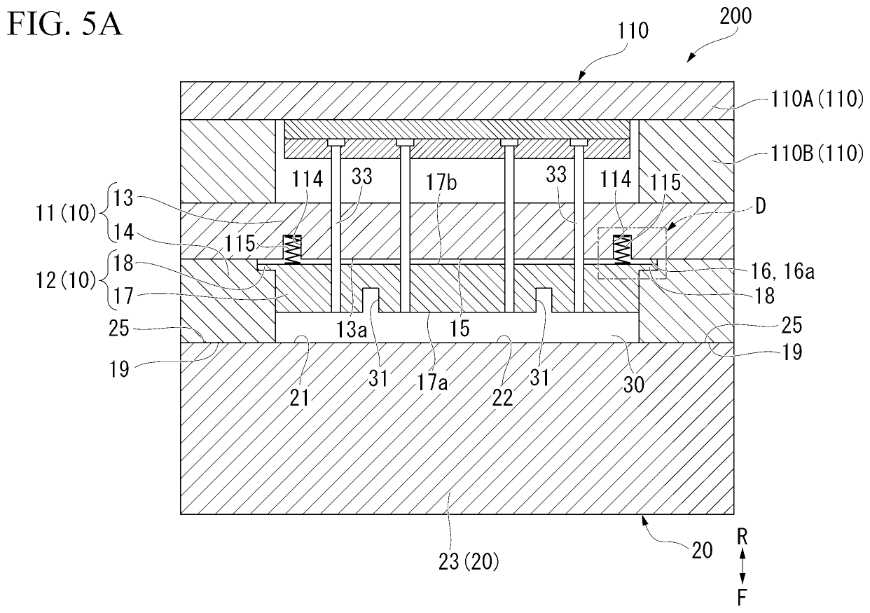

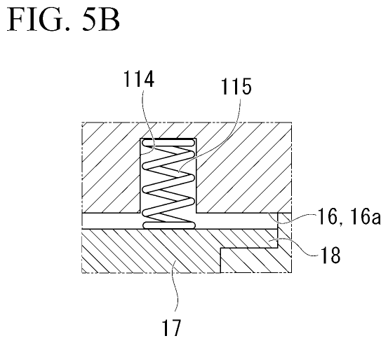

FIGS. 5A and 5B are cross-sectional front views showing injection molding die 200 according to the second embodiment (hereinbelow, also referred to as “die 200”). Note that, identical reference numerals are used for the elements which are common to those of the above-described embodiment and the second embodiment, and explanations thereof are omitted.

The die 200 includes a first die 110 and the second die 20.

The first die 10 includes a top plate 110A, a side portion 110B, the first body part 11, and the first movable piece 12. The top plate 110A and the side portion 110B correspond to the top plate 10A and the side portion 10B according to the aforementioned first embodiment, respectively.

An accommodating recess 114 is formed on the ceiling surface 13a of the based wall portion 13 of the first die 110. A force-applying body 115 is provided in the accommodating recess 114. An upper end of the force-applying body 115 is in contact with a ceiling surface of the accommodating recess 114, and a lower end of the force-applying body 115 is in contact with the upper surface 17b of the movable-piece main body 17. The force-applying body 115 applies a reaction force to the ceiling surface of the accommodating recess 114 and applies a force to the first movable piece 12 downward (forward movement direction). The force-applying body 115 may be an elastic body such as a coil spring, a plate spring, or the like. Note that, the force-applying body has only to be able to prompt the first movable piece 12 to move forward by pressing along with the volume contraction of the resin in the cooling step, and the configuration of the force-applying body is not limited. For example, an oil hydraulic cylinder or the like can be adopted.

### (Method of Manufacturing Molded Product)

### Second Embodiment

### (First Step: Injecting and Filling Step)

The resin is injected and filled to the inside of the cavity 30 in a state in which the temperatures of the first die 110 and the second die 20 are higher than the deformation temperature of the injecting and filling resin. At this time, the first movable piece 12 moves backward due to the resin pressure. In accordance with the backward movement of the first movable piece 12, the force-applying body 115 is compressed.

### (Second Step: Cooling Step)

The first movable piece 12 moves forward along with the volume contraction of the resin. At this time, the force-applying body 115 presses the first movable piece 12 in the forward movement direction and prompts the first movable piece 12 to move forward. Because of this, the volume of the cavity 30 is reduced, and a state in which the resin is in close contact with both the main-body-back-side molding surface 17a and the design-surface molding surface 22 is maintained until cooling is completed. Therefore, sink is prevented from being generated on the resin molded product 1.

### (Third Step: Demolding Step)

The first die 110 and the second die 20 are opened and the resin molded product 1 (refer to FIGS. 2A and 2B) is demolded.

### (Effect Obtained by Second Embodiment)

Since the injection molding die 200 includes the force-applying body 115 that applies a force to the first movable piece 12 in the forward movement direction, the forward movement of the first movable piece 12 is prompted in the cooling step, and it is possible to maintain a state in which the resin is in close contact with the main-body-back-side molding surface 17a. Therefore, sink is prevented from being generated on the molded product.

### (Injection Molding Die)

### Third Embodiment

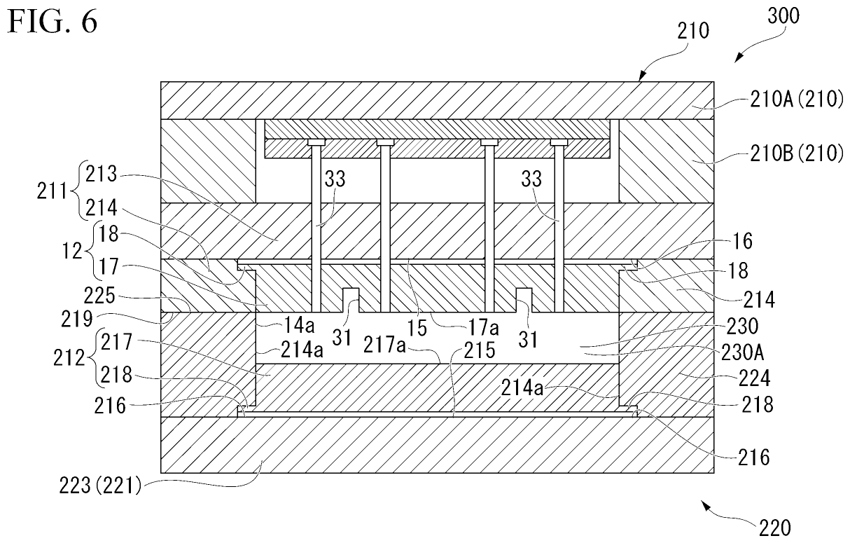

FIG. 6 is a cross-sectional front view showing injection molding die 300 according to the third embodiment (hereinbelow, also referred to as “die 300”). Note that, identical reference numerals are used for the elements which are common to those of the above-described embodiment and the third embodiment, and the explanations thereof are omitted.

The die 300 include a first die 210 and a second die 220. A cavity 230 (air space) is ensured between the first die 210 and the second die 220 (particularly, between the first movable piece 12 and a second movable piece 212).

The first die 210 includes a top plate 210A, a side portion 210B, a first body part 211, and the first movable piece 12. The top plate 210A and the side portion 210B correspond to the top plate 10A and the side portion 10B according to the aforementioned first embodiment, respectively.

The first body part 211 includes a based wall portion 213 and a side wall portion 214 that protrudes downward from a peripheral edge portion of the based wall portion 213. The recess formed by the based wall portion 213 and the side wall portion 214 is the first molding recess 15. Reference numeral 219 represents a lower surface of the first body part 211 which forms a parting surface.

The second die 220 includes a second body part 221 and the second movable piece 212. The second body part 221 has the configuration as that of the first body part 211. That is, the second body part 221 includes a based wall portion 223 and a side wall portion 224 that is provided at a peripheral edge portion of the based wall portion 223. The recess formed by the based wall portion 223 and the side wall portion 224 is referred to as a second molding recess 215. A receiving recess 216 having the same configuration as that of the receiving recess 16 is formed at a lowermost portion of an inner surface 214a of the side wall portion 224. Reference numeral 225 represents an upper surface of the side wall portion 224 which forms a parting surface.

The second movable piece 212 includes a movable-piece main body 217 and a stopper 218. The second movable piece 212 is accommodated in the second molding recess 215.

The movable-piece main body 217 is formed in a plate shape parallel to the based wall portion 223. An upper surface of the movable-piece main body 217 (a surface facing a main-body molding region 230A of the cavity 230) is a design-surface molding surface 217a (second molding surface) that is used to mold the design surface 1b of the resin molded product 1. The design-surface molding surface 217a is formed in a flat shape. Regarding the second movable piece 212, a forward direction means an upward direction shown in FIG. 6, and a backward direction means a downward direction shown in FIG. 6.

Note that, the design-surface molding surface has only to be able to mold at least part of the back surface of the resin molded product. For example, of the design surface of the molded product, the design-surface molding surface may be in contact with only a region in which it is necessary to avoid generating sink.

Similar to the stopper 18 (refer to FIGS. 1A and 1B), the stopper 218 protrudes from a side portion of the movable-piece main body 217 in a lateral direction. The stopper 218 is inserted into the receiving recess 216. Since the thickness of the stopper 218 is smaller than the size of the receiving recess 216 in the front-back direction, the second movable piece 212 is movable in the front-back direction (in a direction of approaching and separating with respect to the main-body-back-side molding surface 17a). That is, the first movable piece 12 of the first die 210 and the second movable piece 212 of the second die 220 are movable in a direction of approaching and separating with respect to each other.

The main-body-back-side molding surface 17a of the first die 210 faces the design-surface molding surface 217a of the second die 220 via the cavity 230.

The cavity 230 is formed by the main-body molding region 230A and the projected-portion molding recess 31. The main-body molding region 230A is a space surrounded by the main-body-back-side molding surface 17a, the design-surface molding surface 217a, and the inner side surfaces 14a and 214a of the side wall portions 14 and 214. The main-body molding region 230A molds the molded-product main body 1a of the resin molded product 1 (refer to FIGS. 2A and 2B). The projected-portion molding recesses 31 mold the molded-product projected portions 1d.

### (Method of Manufacturing Molded Product)

### Third Embodiment

### (First Step: Injecting and Filling Step)

The resin is injected and filled to the inside of the cavity 230 in a state in which the temperatures of the first die 210 and the second die 220 are higher than the deformation temperature of the injecting and filling resin. At this time, the first movable piece 12 and the second movable piece 212 move backward due to the resin pressure.

### (Second Step: Cooling Step)

One or both of the first movable piece 12 and the second movable piece 212 moves forward along with the volume contraction of the resin. Consequently, a state in which the resin is in close contact with both the main-body-back-side molding surface 17a and the design-surface molding surface 217a is maintained until cooling is completed. Therefore, sink is prevented from being generated on the resin molded product.

### (Third Step: Demolding Step)

The first die 210 and the second die 220 are opened, and the resin molded product 1 (refer to FIGS. 2A and 2B) is demolded.

### (Effect Obtained by Third Embodiment)

The injection molding die 300 causes both the first movable piece 12 and the second movable piece 212 to be movable in the front-back direction. Therefore, in the cooling step, even in the case in which the forward movement distance of each of the first movable piece 12 and the second movable piece 212 is small, it is possible to correspond to the volume contraction of the resin. Accordingly, a state in which the resin is in close contact with the main-body-back-side molding surface 17a and the design-surface molding surface 217a is easily maintained. As a result, it is possible to prevent sink from being generated on the resin molded product 1.

### (Modified Example of Third Embodiment)

Although the configuration is described in which both the first movable piece 12 and the second movable piece 212 are movable in the front-back direction in the aforementioned third embodiment, the invention is not limited to this configuration. For example, a configuration not including the first movable piece 12, that is, a configuration in which the second movable piece 212 is only movable in the front-back direction may be adopted. Even in this case, sink is prevented from being generated on the molded product.

### (Injection Molding Die)

### Fourth Embodiment

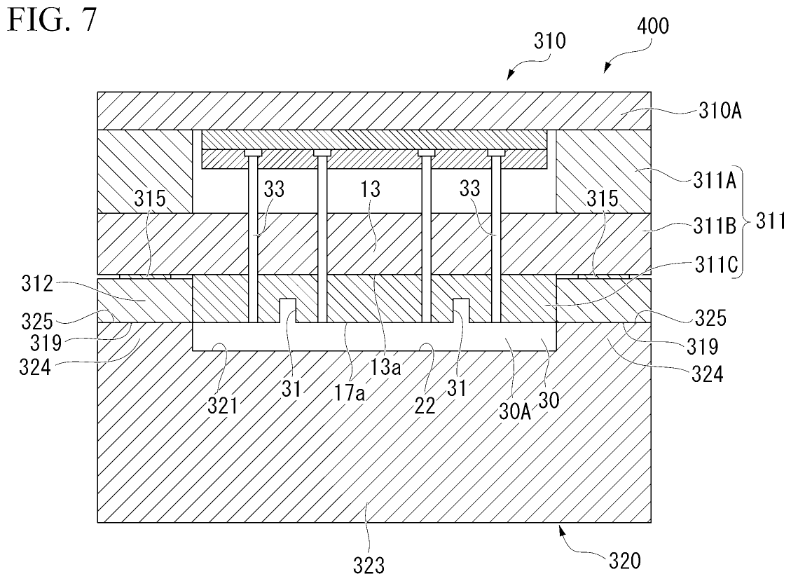

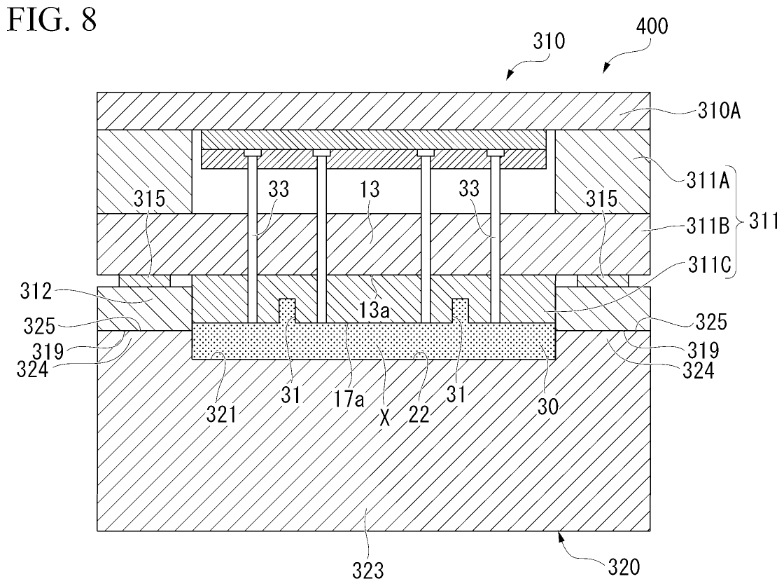

FIG. 7 is a cross-sectional front view showing injection molding die 400 according to the fourth embodiment (hereinbelow, also referred to as “die 400”). Note that, identical reference numerals are used for the elements which are common to those of the above-described embodiment and the fourth embodiment, and the explanations thereof are omitted.

As shown in FIG. 7, the die 400 includes a first die 310 and a second die 320.

The first die 310 includes a top plate 310A and a first body part 311. The first body part 311 includes a side portion 311A, the based wall portion 13 (311B), and a core-die-main-body part 311C. A movable piece 312 is fixed to the based wall portion 13 (311B) by a fastening member such as a bolt or the like which is not shown in the drawings and can change a distance from a based wall portion 311B due to expansion and contraction of a force-applying body 315 (described below). The lower surface 319 of the movable piece 312 forms a parting surface.

The core-die-main-body part 311C is formed in a plate shape. A lower surface of the core-die-main-body part 311C (a surface facing the main-body molding region 30A of the cavity 30) is the main-body-back-side molding surface 17a (first molding surface).

Even in the case in which the distance between the first die 310 and the second die 320 varies, the force-applying body 315 presses the movable piece 312 against the second die 320 from the first die 310 and thereby prevents the parting surface (matching surface between the surface 319 and the surface 325) from being opened. The force-applying body 315 is an elastic body such as a disk spring or the like. Note that, the force-applying body 315 has only to be able to prompt the movable piece 312 to move forward by pressing the movable piece when the die is opened by the resin pressure in the injecting and filling step, and the configuration of the force-applying body 315 is not limited.

The second die 320 includes a base portion 323 and a side wall portion 324 that protrudes upward from a peripheral edge portion of the base portion 323. A recess that is formed by the base portion 323 and the side wall portion 324 is referred to as a second molding recess 321. The inside bottom surface 22 (second molding surface) of the second molding recess 321 is the design-surface molding surface 22. Reference numeral 325 represents a front-end face of the side wall portion 324 which surrounds an opening of the second molding recess 321 and forms a parting surface.

### (Method of Manufacturing Molded Product)

### Fourth Embodiment

### (First Step: Injecting and Filling Step)

As shown in FIG. 8, the resin X is injected and filled to the inside of the cavity 30 in a state in which the temperatures of the first die 310 and the second die 320 are higher than the deformation temperature of the injecting and filling resin and a mold clamping force is set to a vale allowing the die to open when the force is lower than the resin pressure. At this time, when the sum of the pressure of the resin X exceeds the mold clamping force, the first die 310 moves backward (that is, moves in the upward direction shown in FIG. 8). Even where the first die 310 moves backward, the movable piece 312 is pressed against the second die 320 by the force-applying body 315, it is possible to maintain a state in which the surfaces 319 and 325 forming a parting surface are in contact with each other.

### (Second Step: Cooling Step)

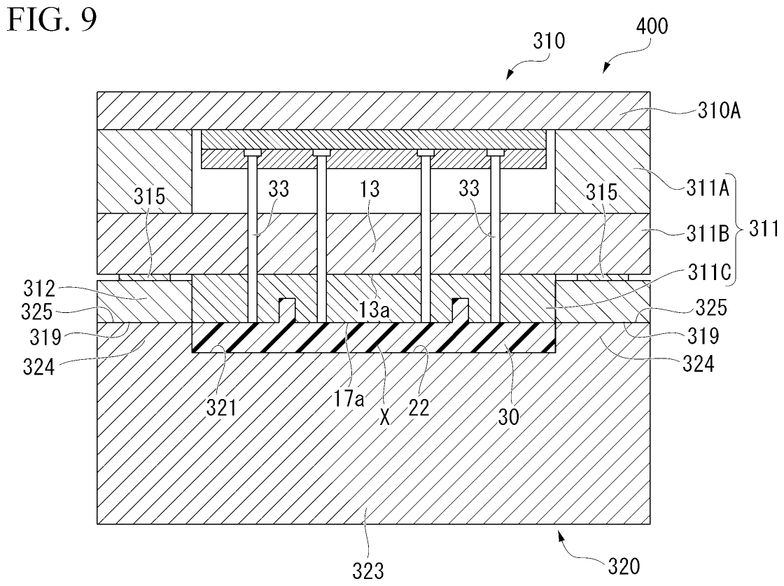

As shown in FIG. 9, the first die 310 moves forward along with the contraction of the resin X due to cooling (that is, moves in the downward direction shown in FIG. 9). At this time, the force-applying body 315 is elastically deformed by the mold clamping force. The cavity 30 is pressed by the first die 310 and the volume thereof is thereby reduced. Consequently, a state in which the resin X is in close contact with both the main-body-back-side molding surface 17a and the design-surface molding surface 22 is maintained until cooling is completed. Therefore, sink is prevented from being generated on the resin molded product 1.

### (Third Step: Demolding Step)

The first die 310 and the second die 320 are opened and the resin molded product 1 (refer to FIGS. 2A and 2B) is demolded.

### (Effect Obtained by Fourth Embodiment)

Since the injection molding die 400 includes the force-applying body 315 that applies a force to the movable piece 312 in the forward movement direction, even where the mold clamping force is lower than the resin pressure and the die is thereby opened, the parting surface (the surfaces 319 and 325) does not open. Accordingly, the forward movement of the first die 310 is prompted in the cooling step that is subsequently carried out, it is possible to maintain a state in which the resin is in close contact with the main-body-back-side molding surface 17a. Therefore, sink is prevented from being generated on the molded product.

### (Injection Molding Die)

### Fifth Embodiment

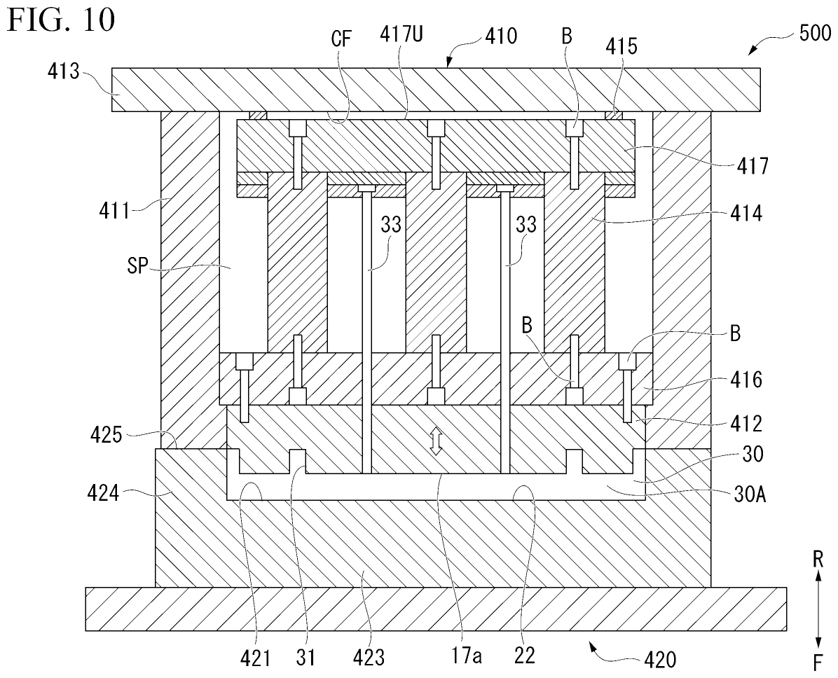

FIG. 10 is a cross-sectional front view showing injection molding die 500 according to the fifth embodiment (hereinbelow, also referred to as “die 500”). Note that, identical reference numerals are used for the elements which are common to those of the above-described embodiment and the fifth embodiment, and the explanations thereof are omitted.

As shown in FIG. 10, the die 500 includes a first die 410 and a second die 420. The first die 410 includes a first body part 411, a first movable piece 412, a top plate 413, a support pillar 414, a force-applying body 415, a lower base 416, and an upper base 417.

The first movable piece 412 is connected and fixed to the lower base 416 by a fastening member B such as a bolt or the like. An upper surface of the support pillar 414 is connected and fixed to the upper base 417 by the fastening member B. A lower surface of the support pillar 414 is connected and fixed to the lower base 416 by the fastening member B.

The upper base 417 is movable in an internal space SP in the direction represented by the arrows R and F due to expansion and contraction of the force-applying body 415. The above-mentioned ejector pins 33 are connected and fixed to the upper base 417.

The first movable piece 412 is formed in a plate shape. The lower surface (a surface facing the main-body molding region 30A of the cavity 30) of the first movable piece 412 is the main-body-back-side molding surface 17a (first molding surface). The first movable piece 412 is movable in the front-back direction (a direction of approaching and separating with respect to the design-surface molding surface 22).

The first movable piece 412 is connected to the upper base 417 via the lower base 416 and the support pillar 414. The first movable piece 412 is movable in the direction represented by the arrows R and F along with the upward and downward movement of the upper base 417.

The force-applying body 415 is disposed between a ceiling surface CF of the top plate 413 and an upper surface 417U of the upper base 417. An upper end of the force-applying body 415 is fixed to the ceiling surface CF, a lower end of the force-applying body 415 is fixed to the upper surface 417U.

The force-applying body 415 applies a force to the upper base 417 and the ceiling surface CF in a direction away from each other. The force-applying body 415 is an elastic body such as a coil spring, a plate spring, a disk spring, or the like. Note that, the force-applying body 415 has only to be able to prompt the first movable piece 412 to move forward by pressing along with the volume contraction of the resin in the cooling step, and the configuration of the force-applying body is not limited.

The second die 420 includes a base portion 423 and a side wall portion 424 that protrudes upward from a peripheral edge portion of the base portion 423. A recess that is formed by the base portion 423 and the side wall portion 424 is referred to as a second molding recess 421. The inside bottom surface (second molding surface) of the second molding recess 421 is the design-surface molding surface 22. Reference numeral 425 represents a front-end face of the side wall portion 424 which surrounds an opening of the second molding recess 421 and forms a parting surface.

### (Method of Manufacturing Molded Product)

### Fifth Embodiment

### (First Step: Injecting and Filling Step)

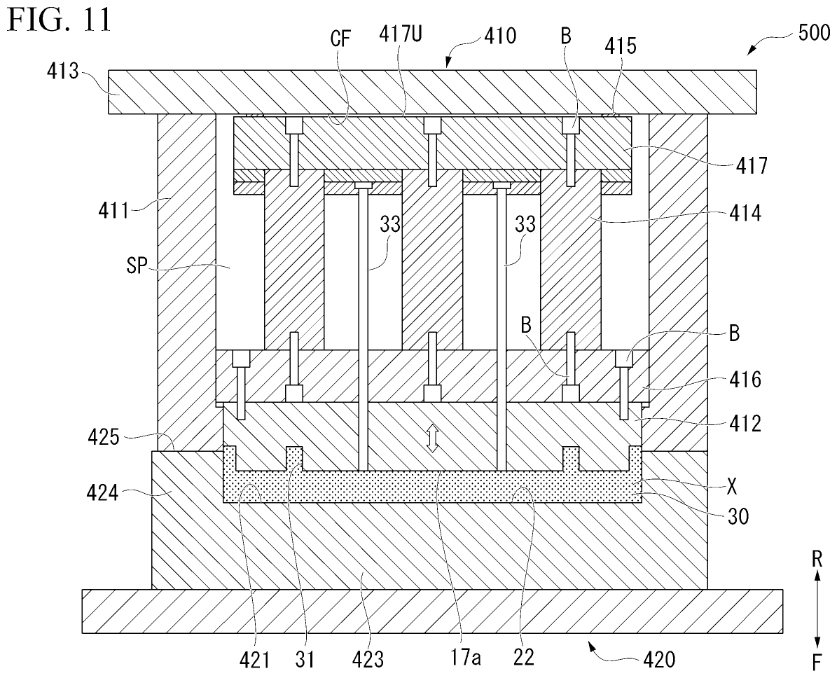

As shown in FIG. 11, the resin X is injected and filled to the inside of the cavity 30 in a state in which the temperatures of the first die 410 and the second die 420 are higher than the deformation temperature of the injecting and filling resin. At this time, the volume of the cavity 30 increases due to the pressure of the resin X and the first movable piece 412 and the upper base 417 move backward (that is, move in the direction shown by the arrow R in FIG. 11). The force-applying body 415 is elastically deformed and compressed along with the backward movement of the upper base 417.

### (Second Step: Cooling Step)

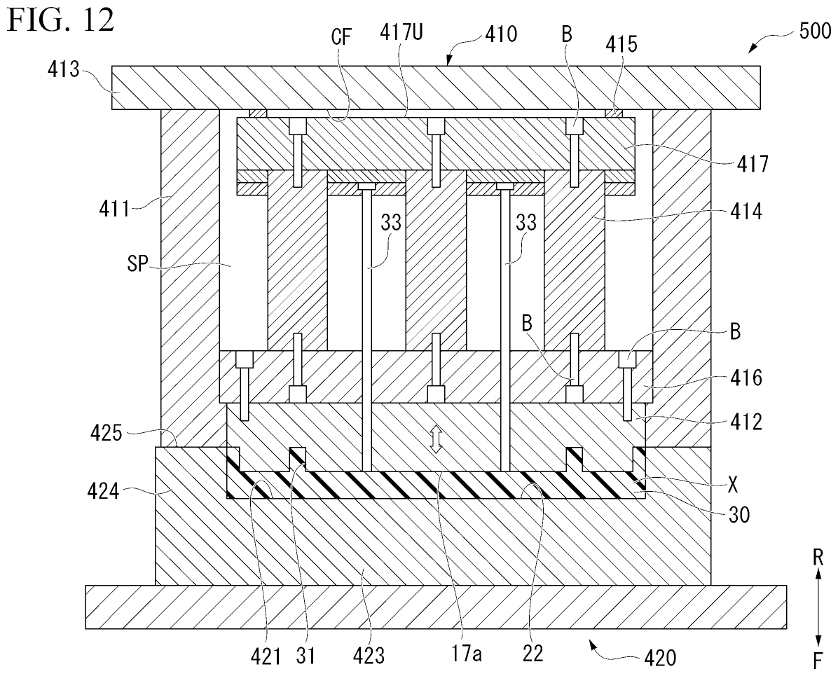

As shown in FIG. 12, the first movable piece 412 moves forward along with the volume contraction of the resin X (that is, moves in the direction shown by the arrow F in FIG. 12). At this time, the force-applying body 415 applies a pressing force to the upper base 417 in the forward movement direction. The first movable piece 412 is pressed by the upper base 417, the forward movement thereof is thereby prompted, and the volume of the cavity 30 is reduced. Consequently, a state in which the resin X is in close contact with both the main-body-back-side molding surface 17a and the design-surface molding surface 22 is maintained until cooling is completed. Therefore, sink is prevented from being generated on the resin molded product 1.

### (Third Step: Demolding Step)

The first die 410 and the second die 420 are opened and the resin molded product 1 (refer to FIGS. 2A and 2B) is demolded.

### (Effect Obtained by Fifth Embodiment)

Since the injection molding die 500 includes the force-applying body 415 that applies a force to the first movable piece 412 in the forward movement direction, the forward movement of the first movable piece 412 is prompted with a decrease in volume of the resin in the cooling step, and it is possible to maintain a state in which the resin is in close contact with the main-body-back-side molding surface 17a. Therefore, sink is prevented from being generated on the molded product.

In addition, the technical scope of the invention is not limited to each of the embodiments described above, and various modifications to the described above embodiments may be made without departing from the scope of the invention. Namely, constitutions or the like described in the above embodiment are examples, and modifications can be appropriately adopted. For example, although the first movable piece 12 is provided in the first die 10 in the die 100 shown in FIGS. 1A and 1B, a movable piece may be provided in the second die without being provided in the first die. A movable piece may be provided in both the first die and the second die (refer to FIG. 6). This means that the movable piece may be provided in any one or both of the first die and the second die.

The injection molding die according to the embodiment has only to have the configuration that can reduce the volume of the cavity due to the contraction of the resin even in the case in which the volume of the cavity does not increase when operation of injecting the resin is carried out. That is, the injection molding die according to the embodiment is the injection molding die used in a molding method of causing a surface of a resin molded product during molding to be brought into close contact with both cavity surfaces of a pair of dies by setting surface temperatures of cavity surfaces of the pair of dies to be higher than a deformation temperature of a resin to be molded and may have a configuration such that the volume of the cavity can be reduced along with the contraction of the resin by cooling.

The injection molding die according to the embodiment may have the following configuration.

An injection molding die that includes: a first die that molds a first main surface of a resin molded product and a second die having a second molding surface that molds at least part of a second main surface which is opposite to the first main surface of the resin molded product, wherein the first die includes: a first body part; and a first movable piece having a first molding surface that molds at least part of the first main surface, and the first movable piece is movable in a direction of approaching and separating with respect to the second molding surface.

In the injection molding die according to the embodiment, the movable piece may not have a configuration that is in contact with all of the back surface of the resin molded product but may have a configuration that is only in contact with one region of the back surface of the resin molded product which has to prevent sink from being generated. In this case, of the back surface of the resin molded product, sink due to external air introduced from the ejector pin holes or the like may be formed on a region other than the region with which the movable piece is brought into contact.

### DESCRIPTION OF REFERENCE NUMERALS

1 . . . resin molded product, 1a . . . molded-product main body, 1b . . . design surface (of a resin molded product) (second main surface), 1c . . . back surface (of a resin molded product) (first main surface), 1d . . . projected portion (of a resin molded product), 10, 110, 210 . . . first die, 11 . . . first body part, 12 . . . first movable piece 17 . . . movable-piece main body, 17a . . . main-body-back-side molding surface (first molding surface, cavity surface), 20, 220 . . . second die, 22 . . . inside bottom surface (design-surface molding surface, cavity surface) (second molding surface), 30 . . . cavity, 100, 200, 300, 400, 500 . . . injection molding die, 115 . . . force-applying body, 211 . . . first body part, 212 . . . second movable piece 217 . . . movable-piece main body, 217a . . . design-surface molding surface (second molding surface).

1. An injection molding die being used in a molding method of causing a surface of a resin molded product during molding to be brought into close contact with both cavity surfaces of a pair of dies by setting surface temperatures of cavity surfaces of the pair of dies to be higher than a deformation temperature of a resin to be molded,
the injection molding die being capable of increasing a volume of the cavity along with operation of injecting the resin to a cavity formed by the pair of dies and reducing a volume of the cavity along with contraction of the resin by cooling.

2. The injection molding die according to claim 1, wherein
the pair of dies are a first die that molds a first main surface of a resin molded product and a second die having a second molding surface that molds at least part of a second main surface which is opposite to the first main surface of the resin molded product,
the first die includes: a first body part; and a first movable piece having a first molding surface that molds at least part of the first main surface, and
the first movable piece is movable in a direction of approaching and separating with respect to the second molding surface.

3. The injection molding die according to claim 2 further comprising a force-applying body that applies a force to the first movable piece in a direction in which the first movable piece approaches the second molding surface.

4. The injection molding die according to claim 2, wherein
the second die includes: a second body part; and a second movable piece having the second molding surface, and
the second movable piece is movable in a direction of approaching and separating with respect to the first molding surface.

5. The injection molding die according to claim 2, wherein
a distance at which the first movable piece is movable in a direction of approaching and separating with respect to the second molding surface is 10% to 20% of thickness of the resin molded product.

6. A method of manufacturing a molded product, comprising:
a step of injecting and filling the resin in a molten state to a cavity between the first die and the second die in a state in which a temperature of an injection molding die according to claim 2 is higher than a deformation temperature of a resin forming the resin molded product; and
a step of causing the first movable piece to move in a direction of approaching the second molding surface along with volume contraction of the resin when cooling the first die and the second die, and thereby molding the resin in a state in which the resin is in close contact with a first molding surface and a second molding surface.
